(19) United States
(12) Patent Application Publication
(10) Pub. No.: US 2008/0051512 A1
(43) Pub. Date: Feb. 28, 2008

(54) Electroluminescent polymer structure

(75) Inventors: Kung-Hwa Wei, Hsinchu (TW); Chia-Hung Chou, Hsinchu (TW)

Correspondence Address: BIRCH STEWART KOLASCH & BIRCH, PO BOX 747, FALLS CHURCH, VA, 22040-0747, US

(73) Assignee: National Chiao Tung University

(21) Appl. No.: 11/586,652

(22) Filed: Oct. 26, 2006

(30) Foreign Application Priority Data
Aug. 22, 2006 (TW) 95130817

(51) Int. Cl. C08F 8/00

(52) U.S. Cl. 525/100

(57) ABSTRACT

One type of electroluminescence polymer that include at least one side-chain-tethered polyhedral oligomeric silsesquioxane that will form self-assembled structure and may build a free volume among the polymers to prevent the polymers from stacking and enhance luminescence efficiency and thermal stability.

### BACKGROUND OF THE INVENTION

1. Field of the Invention

The present invention relates to an electroluminescent (EL) polymer material, particularly to a red luminescent polymer material.

2. DESCRIPTION OF THE RELATED ART

Most of electroluminescent polymers present more efficient injection and transmission of electric holes than ones of electrons due to the existence of abundant π electrons. Thus, in order to enhance the efficiency of a device, the incorporation of electron transmission is necessary. Polyquinoline and its derivatives have been applied to a layer of electron transmission for LED recently because they perform high thermal stability, high anti-oxidation, good mechanical characteristic, a good formation capability. However, poor solubility is disadvantageous for their applications.

The derivatives of fluorene may present specifically physical and chemical characteristics in the presence of rigid and coplanar biphenyl configuration. Next, polyfluorenes functionalized by modifying the C-9 position of the fluorine monomer may provide good solubility without raising steric hindrances among polymer backbones. Furthermore, fluorine exhibits high quantum efficiency and good thermal stability. As a result, the expected blue emission from polyfluorene becomes an attracting material in application. However, the main drawbacks of polyfluorenes (PFs) are the formation of excimer and aggregates during heat or circuit treatment. Moreover, the C-9 position of the fluorine monomer leads to keto defect and further results in luminescence change. Meanwhile, how to modify light color is another issue about studying the derivates of PFs. One of the most recent approaches involves introduction of PFs into green and red luminescent material. Another one of the approaches involves the copolymerization of PFs and monomers with low energy level. For example, the 5 mol % amount of monomers incorporated with PFs may modify light color from blue to yellow and green. Generally, the color of luminescence may be efficiently modified by incorporating monomers with low energy into PFs. So far, besides few reports about blue light modified to red light, most of researches are relevant to yellow and green light. Accordingly, there is still room for improvement and growth about luminescence color, emitting efficiency, mass production, heat resistance and life time. For example, FIG.—1 is a schematic diagram illustrating polymer modification with tethered polyhedral oligomeric silsesquioxane (POSS). Conventionally, POSS 112 is introduced into the main chain 110 of a polymer. Such as a configuration enhances mechanical strength and heat resistance. However, the freedom degree restricted by the presence of POSS 112 on main chain 110 of the polymer may not reduce dielectric constant efficiently.

### SUMMARY OF THE INVENTION

In order to enhance heat resistance of luminescent polymer, one of objects of the present invention provides a luminescent polymer material with inorganic material attached covalently to a side chain on the main chain of a polymer, which may enhance luminescent efficiency, heat stability and resistance.

Another one of objects of the present invention is to provide a red luminescent polymer with porous material in steric hindrance configuration introduced into a side chain, which not only prevents polymer chains from approaching too much and resulting in molecule aggregation but also improves solubility.

Moreover, one of objects of the present invention is to provide polymer nano-composites. Tethered polyhedral oligomeric silsesquioxane is introduced on the main chain of a polymer to enhance quantum efficiency. Accordingly, one embodiment of the present invention is to provide red light luminescent polymer. The main chain of the polymer is associated with inorganic composition on a side chain so as to form self-assembly structure.

### BRIEF DESCRIPTION OF THE DRAWINGS

FIG.—1 is a schematic diagram illustrating polymer modification with tethered polyhedral oligomeric silsesquioxane (POSS).

FIG. 2 is a schematic diagram illustrating copolymer with tethered polyhedral oligomeric silsesquioxane in accordance with one embodiment of the present invention.

FIG. 3 is a schematic table illustrating the reaction of copolymer in accordance with the present invention.

FIG. 4 is a schematic diagram illustrating comparison of characteristics for inorganic material with steric hindrance in combination of polymer in accordance with the present invention.

FIG. 5 is a schematic diagram illustrating comparison of characteristics for MEHPPV and POSS-PPV10-co-MEHPP.

FIG. 6 is a schematic diagram illustrating the luminescence of various polymers in accordance with the present invention.

FIG. 7 is a schematic diagram illustrating the relationships of voltage and luminescence for different copolymer applied to any luminescence devices in accordance with the present invention.

FIG. 8 is a schematic diagram illustrating the luminescence for different devices in accordance with the present invention.

### DETAILED DESCRIPTION OF THE INVENTION

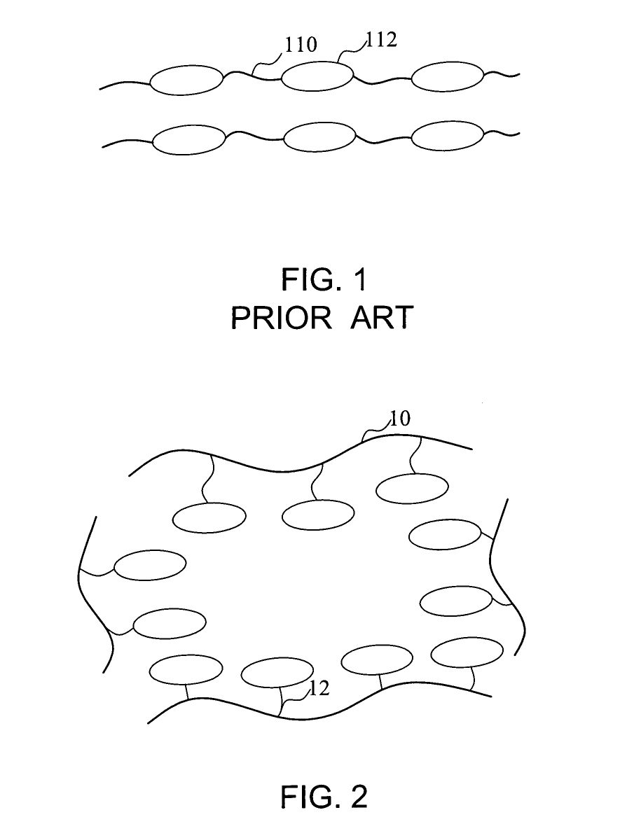

FIG. 2 is a schematic diagram illustrating copolymer with tethered polyhedral oligomeric silsesquioxane in accordance with one embodiment of the present invention. In one embodiment, each copolymer is provided with a main chain 10 and one or more side chains 12. The main chain 10 includes luminescent polymer, such as conjugated polymer. The side chain 12 includes inorganic material with steric hindrance, such as caged polyhedral oligomeric silsesquioxane (POSS). POSS dangling on a side chain may present much freedom degree and attract each another when compared with a conventional POSS on one end of main chain. However, any two neighboring copolymers may main a distance due to the existence of the POSS in steric hindrance configuration, which is called self-assembly structure.

Accordingly, special volume enlarges upon increasing free volume between copolymers, which may reduce the dielectric constant of a copolymer with POSS. Moreover, compared with one prior art having POSS at two ends of a main chain, the POSS according to the present invention is introduced into the side chain of one main chain to enhance mechanical property, thermal stability, heat resistance and luminescence efficiency. Such a side-chain-tethered POSS polymer may be applied to various polymer photoelectric devices, such as electroluminescence LED plate display, plate luminescence source, solar cell, plastic IC or sensor, and so on.

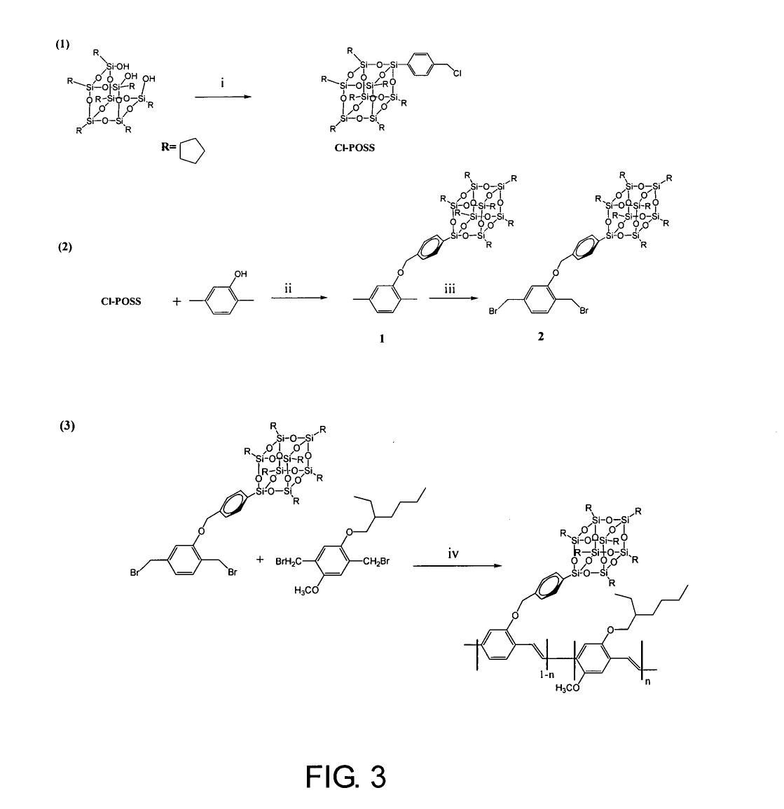

FIG. 3 is a schematic diagram illustrating the reaction of copolymer in accordance with the present invention. 2,5-Dimethylphenol (238 mg, 1.95 mmol) is stirred with K₂CO₃(4.58 mg, 33.18 mmol), KI (1.57 g, 9.48 mmol) in DMF (30 ml) and THF (15 ml) at room temperature for 1 hour. A small amount of Chlorobenzylcyclopentyl-POSS is added, and then the whole mixture is heated at 70 for 3 hours. The reaction mixture is then extracted, dried and purified to collect POSS-CH₃. Next, a mixture of POSS-CH₃ (600 mg, 0.510 mmol), NBS (198.6 mg, 1.02 mmol) and AlBN (8.0 mg) is heated under reflux, filtered and purified to collect POSS-CH₂Br. Next, a conjugated copolymer, POSS-PPV(p-phenylenevinylene)-co-MEHPPV(poly(2-methoxy-5-[2-ethylhexyloxy]-1,4-phenylenevinylene) is synthesized by Gilch polymerization method.

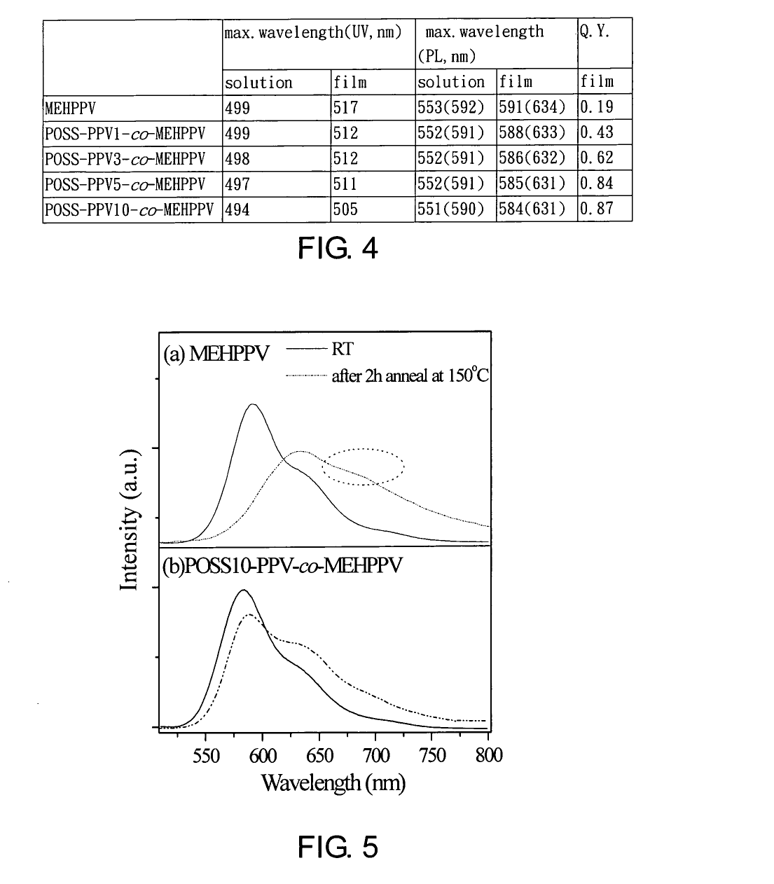

FIG. 4 is a schematic table illustrating comparison of characteristics for inorganic material with steric hindrance in combination of polymer in accordance with the present invention. In the figure, raw MEHPPV is compared with copolymer with different amounts of POSS-PPV, absorbed or emitting wavelength is measured in THF. The data in parenthesis are the wavelengths of the shoulders and subpeaks. The quantum yield of photoluminescence (PL) are estimated relative to Rhodamine 6G (._{FL}=0.95). Shown in the figure, the quantum efficiency of POSS-PPV10-co-MEHPPV may reach to 0.87. Moreover, the full width at half maximum is very advantageously narrow (smaller than 100 nm) for the color purity.

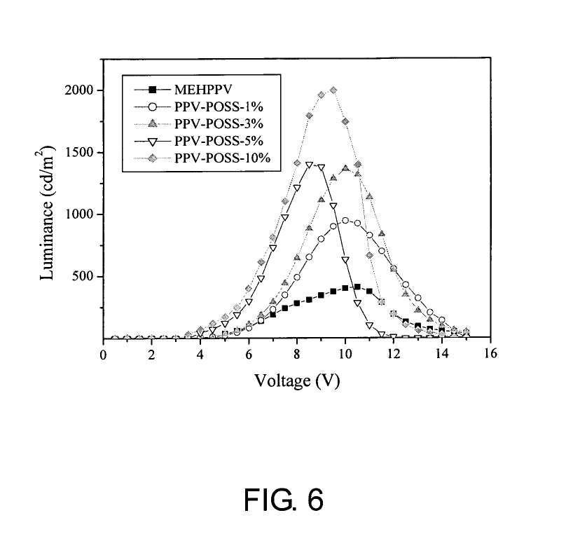

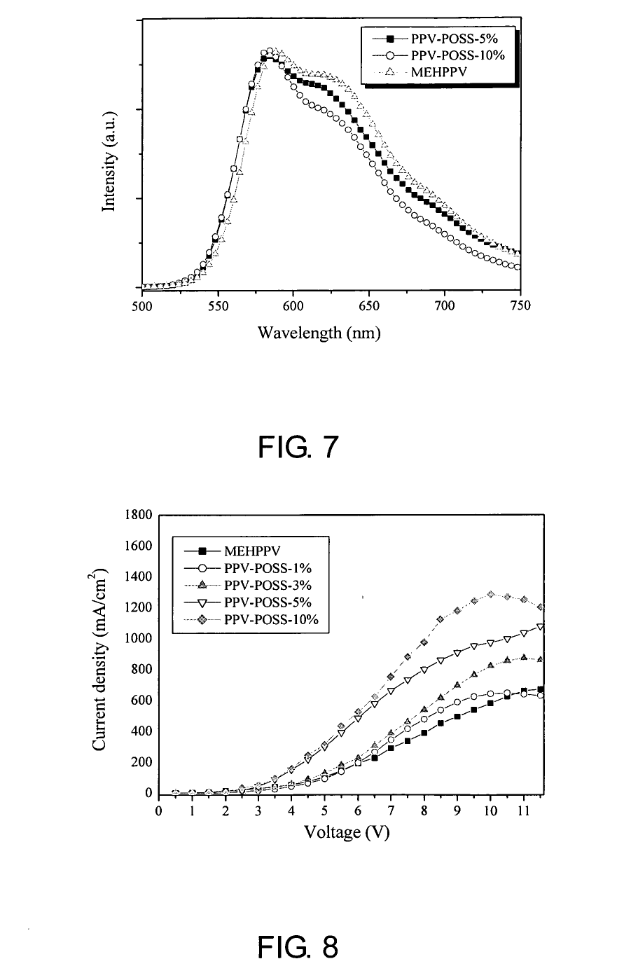

FIG. 5 is a schematic diagram illustrating comparison of characteristics for MEHPPV and POSS-PPV10-co-MEHPPV in accordance with the present invention. For exemplary luminescence device with double structure of ITO/PEDOT (Poly-3,4-Ethylenedioxythiophene): PSS/polymer/Calcium/aluminum, after an applied device is annealed at 150 for 2 hours, the PPV with the side-chain-tethered POSS presents enhanced thermal characteristics. FIG. 6 is a schematic diagram illustrating the luminescence of various polymers in accordance with the present invention. Shown in the figure, the electroluminescence (EL) of a conjugated polymer MEHPPV emits reddish orange light (the wavelength 590 nm). After the incorporation of POSS, the full width at half maximum of a conjugated polymer reduced sharply about from 110 nm to 75 nm. The original color purity is improved due to the restrained excimer by the existence of POSS. FIG. 7 is a schematic diagram illustrating the relationships of voltage and luminescence for different copolymer applied to any luminescence devices in accordance with the present invention. It is observed that the luminescence efficiencies of the devices may be improved upon increasing incorporated side-chain-tethered POSS. For a conjugated polymer MEHPPV, the luminance thereof is only 473 cd/m². On the other hand, one device with incorporation of 10% POSS-PPV presents the luminance of a device is about 2196 cd/m² which is more than 4 times compared to general one. Furthermore, shown in FIG. 8, when incorporated with increasing side-chain-tethered POSS, the device may load more currents. For example, one device with 10% POSS-PPV copolymer, the loaded current presents two times values when compared with original MEHPPV.

Although the present invention has been explained in relation to its preferred embodiment, it is to be understood that other modifications and variation can be made without departing the spirit and scope of the invention as hereafter claimed.

What is claimed is:

1. An electroluminescence polymer material comprising a polymer main chain and at least a side chain linked on said polymer main chain, wherein said side chain comprises an inorganic compound with a steric hindrance.

2. An electroluminescence polymer material according to claim 1, wherein said polymer main chain comprises a copolymer.

3. An electroluminescence polymer material according to claim 2, wherein said copolymer comprises an incorporation of poly (1,4-phenylene vinylene) (PPV) and conjugated polymer (poly(2-methoxy-5-[2-ethylhexyloxy]-1,4-phenylenevinylene) (MEHPPV).

4. An electroluminescence polymer material according to claim 1, wherein said side chain comprises a polyhedral oligomeric silsesquioxane (POSS).

5. An electroluminescence polymer material according to claim 4, wherein said polyhedral oligomeric silsesquioxane is linked to said polymer main chain containing poly(1,4-phenylene vinylene).

6. A red luminescence polymer material comprising a polymer main chain and at least a side chain linked on said polymer main chain, wherein said side chain comprises polyhedral oligomeric silsesquioxane (POSS).

7. A red luminescence polymer material according to claim 6, wherein said polymer main chain comprises an incorporation of poly(1,4-phenylene vinylene) (PPV) and conjugated polymer (poly(2-methoxy-5-[2-ethylhexyloxy]-1,4-phenylenevinylene) (MEHPPV).

8. A red luminescence polymer material according to claim 6, wherein said polyhedral oligomeric silsesquioxane is linked onto said poly(1,4-phenylene vinylene).
